(19) United States
(12) Patent Application Publication
(10) Pub. No.: US 2007/0038581 A1
(43) Pub. Date: Feb. 15, 2007

(54) Web terminal and bridge that support passing of authentication data to acquirer for payment processing

(76) Inventors: Michael A. Keresman III, Kirtland Hills, OH (US); Chandra Balasubramanian, Lakewood, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/501,638

(22) Filed: Aug. 9, 2006

Related U.S. Application Data
(60) Provisional application No. 60/706,738, filed on Aug. 9, 2005.

(51) Int. Cl. G06Q 99/00

(52) U.S. Cl. 705/64

(57) ABSTRACT

A method is provided for passing authentication data to a third party that processes a transaction. More specifically, in connection with a transaction conducted between a first party and a second party, wherein a plurality of transaction details related to the transaction are generated, including a transaction ID which identifies the transaction and authentication data which reflects a result of an attempt to authenticate the first party, the method includes: providing the second party a document over a communications network, said document requesting a transaction ID; receiving the transaction ID over the communications network from the second party; collecting the transaction details corresponding to the received transaction ID; identifying the authentication data within the collected transaction details; formatting the transaction details according to a prescribed format; and, forwarding the formatted transaction details to the third party.

This application claims the benefit of U.S. Provisional Application Ser. No. 60/706,738, filed Aug. 9, 2005, which is incorporated herein by reference in its entirety.

### FIELD

The present inventive subject matter relates to the art of identity authentication. It finds particular application in conjunction with supporting cardholder authentication for payment processing of Internet based commercial transactions (i.e., electronic commerce), and it will be described with particular reference thereto. However, one of ordinary skill in the art will appreciate that it is also amenable to other like applications.

### BACKGROUND

Internet commerce, or e-commerce as it is otherwise known, relates to the buying and selling of products and services between consumers and merchants over the Internet or other like transactional exchanges of information. The convenience of shopping over the Internet has sparked considerable interest in e-commerce on behalf of both consumers and merchants. Internet sales, or like transactions, have been typically carried out using standard credit cards such as Visa®, MasterCard®, Discover®, American Express®, or the like, or standard debit cards, i.e., check cards or automated teller machine (ATM) cards which directly access funds from an associated deposit account or other bank account.

While widely used for more traditional face-to-face transactions, use of these standard cards in connection with e-commerce presents certain difficulties, including difficulties concerning authentication or positive identification of the cardholder. For example, maintaining consumer confidence in security has become difficult with increased reports of fraud. The resulting apprehension is also fueled by consumer uncertainty of the reputation or integrity of a merchant with whom the consumer is dealing. Questionable security of the consumer's card information or other personal information typically submitted along with a traditional e-commerce transaction (e.g., address, card number, phone number, etc.) serves to increase apprehension even more. Additionally, cardholders, merchants and financial institutions are all concerned about safeguarding against fraudulent or otherwise unauthorized transactions.

Accordingly, various credit card or payment networks have implemented initiatives or programs aimed at safeguarding against fraud. Payment networks (e.g., Visa® and MasterCard®) have implemented various initiatives (e.g., Visa 3-D Secure®, a.k.a. Verified by Visa® (VbV), and MasterCard® SecureCodeTM) to allow for the authentication of a cardholder prior to authorizing a transaction. For example, some of these authentication initiatives work by having a cardholder connect to the card issuing bank for authentication. The cardholder authenticates with the bank by connecting to a server over the Internet that stores authentication credentials for that cardholder, whether it be a password, public key infrastructure (PKI) credential, biometric credential, or some other credential. The bank then sends an authentication message or data (based on success or failure) back to the merchant. Often, this is all carried out over the Internet. The benefits of such authentication protocols to all the parties involved in the transaction have been acknowledged.

However, many merchants and others are still not suitably equipped to properly comply with the authentication initiatives. For example, many on-line or Internet merchants (as well as other types of merchants, e.g., mobile merchants, so called brick and mortar merchants, etc.) employ back-end accounting and/or order managements systems which are commonly used to pass or transmit card transactions to acquirers, e.g., merchant banks, payment processing gateways, or the like. On behalf of the merchant, the acquirer then presents or submits the transactions over the appropriate payment network in the usual manner to the card issuing banks or the like for payment. For the merchant to enjoy the full advantage of the benefits of the various authentication initiatives, commonly, the aforementioned authentication data has to accompany the transactions submitted over the payment network. Nevertheless, many back-end accounting and/or order management systems currently used by merchants are not equipped to properly pass the authentication data to the acquirer so that it may be submitted with the transaction for payment.

For example, insomuch as an OMS or the like may have been implemented or installed prior to adoption of the authentication protocols or initiatives, there may not be an extra place or field in which to store the authentication data along with the particular transaction associated therewith. That is to say, the OMS may have no means to receive and/or record the authentication data along with other associated transaction detail. Accordingly, the OMS simply has no authentication data to pass to the acquirer. One solution to this problem is for the merchant to upgrade or replace their OMS or back-end accounting system. This solution however can be costly and therefore undesirable.

Even if the OMS were originally provisioned with one or more extra fields to accommodate future growth and/or an expanded set of data values for each transaction, problems may still arise. For example, while the OMS can now accommodate receipt and/or recording of the authentication data along with the other transaction details, it may still not recognize the data as authentication data. When provisioning an OMS for future expansion, the nature of that expansion is not always appreciated or known at the time. Accordingly, any extra or expansion fields provisioned are often labeled as “miscellaneous” or with another such nondescript or generic label. That is to say, the OSM will generally have no particular way to identify the nature or particular type of data that is recorded or contained in these extra or spare fields. Accordingly, it may not be programmed or otherwise equipped. to pass this field to the acquirer along with the other transaction details. Moreover, even if the data in the miscellaneous field is passed to the acquirer, being that the OMS does not recognize it as authentication data, it may not be formatted as a particular acquirer is expecting, it may not be passed in proper sequence to the acquirer (i.e., in the location expected by the particular acquirer relative to the other transaction details), or it may not be otherwise identifiable by the acquirer as authentication data. Accordingly, the acquirer may not accept the seemingly extraneous data or may not known what to do with it, in which case the authentication may still not be is not properly submitted with its associated transaction over the payment network.

Accordingly, a new and improved system and/or method that supports the passing of authentication data in conjunction with its associated transaction details for payment processing is disclosed that overcomes the above-referenced problems and others.

### BRIEF DESCRIPTION

In accordance with one exemplary embodiment, a method is provided for passing authentication data to a third party that processes a transaction. More specifically, in connection with a transaction conducted between a first party and a second party, wherein a plurality of transaction details related to the transaction are generated, including a transaction ID which identifies the transaction and authentication data which reflects a result of an attempt to authenticate the first party, the method includes: providing the second party a document over a communications network, the document requesting a transaction ID; receiving the transaction ID over the communications network from the second party; collecting the transaction details corresponding to the received transaction ID; identifying the authentication data within the collected transaction details; formatting the transaction details according to a prescribed format; and, forwarding the formatted transaction details to the third party.

In accordance with another exemplary embodiment, a system is provided for passing authentication data to a third party which processes a transaction. More specifically, in connection with a transaction conducted between a first party and a second party, wherein a plurality of transaction details related to the transaction are generated, including a transaction ID which identifies the transaction and authentication data which reflects a result of an attempt to authenticate the first party, the system includes: means for providing the second party a document over a communications network, the document requesting a transaction ID; means for receiving the transaction ID over the communications network from the second party; means for collecting the transaction details corresponding to the received transaction ID; means for identifying the authentication data within the collected transaction details; means for formatting the transaction details according to a prescribed format; and, means for forwarding the formatted transaction details to the third party.

In accordance with another exemplary embodiment, a method is provided for passing transaction details to a third party which processes the transaction. In connection with a transaction conducted between a first party and a second party, wherein a plurality of transaction details related to the transaction are generated, including a transaction ID which identifies the transaction, the method includes: providing the second party a document over a communications network, the document requesting a transaction ID; receiving the transaction ID over the communications network from the second party; collecting the transaction details corresponding to the received transaction ID; identifying the collected transaction details; formatting the transaction details according to a prescribed format; and, forwarding the formatted transaction details to the third party.

Numerous advantages and benefits of the inventive subject matter disclosed herein will become apparent to those of ordinary skill in the art upon reading and understanding the present specification.

### BRIEF DESCRIPTION OF THE DRAWINGS

The present inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration showing an on-line transaction processing system suitable for practicing aspects of the present inventive subject matter.

FIGS. 2A and 2B are diagrammatic illustrations of transaction records supported by an accounting/order management system and/or transaction database shown in FIG. 1.

FIG. 3 is a diagrammatic illustration showing an authentication bridge and web terminal embodying aspects of the present inventive subject matter.

### DETAILED DESCRIPTION

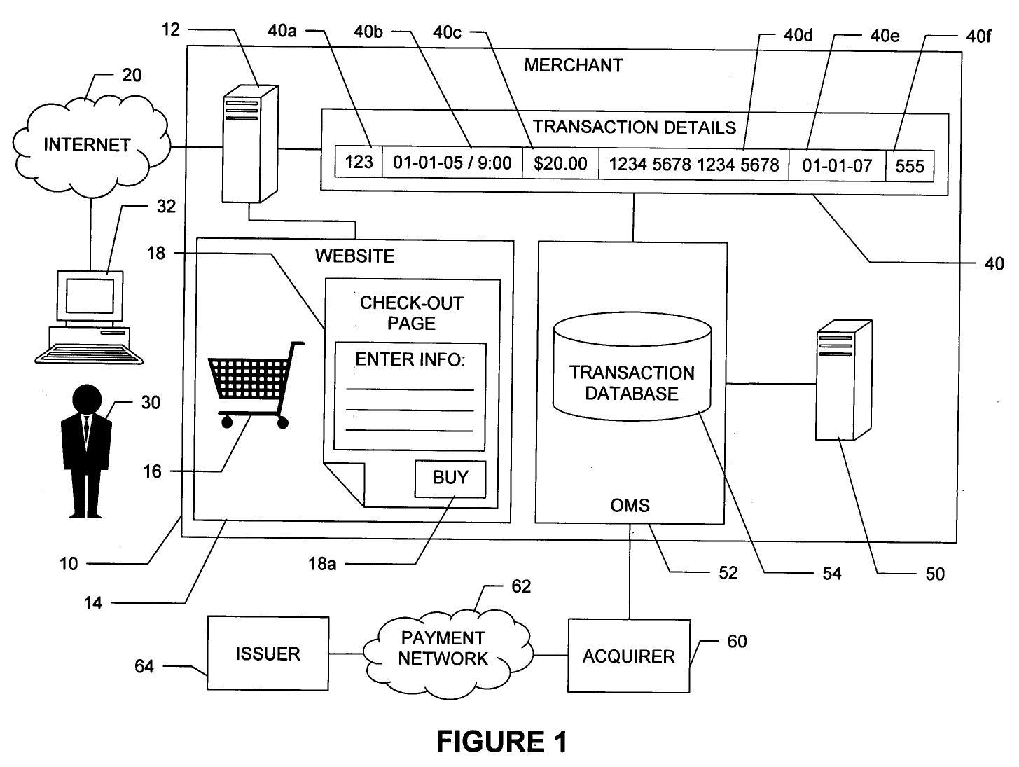

With reference to FIG. 1, there is shown an on-line or Internet merchant 10 or other like entity or proxy therefor employing a web server 12 or other similar computer operatively connected to the Internet 20 or other like network to host a website 14 in the usual manner. A consumer or cardholder 30, e.g., employing a web or Internet browser running on a computer 32 or other like Internet access device, selectively connects to the server 12 over the Internet 30 to access and/or shop at the hosted website 14. Suitably, the server 12 provides or otherwise supports what is known as a shopping cart program or function 16 for the website 14. Via the shopping cart 16, the cardholder 30 selects various items to purchase, and then proceeds to the website's check-out webpage 18 or the like provided by the server 12. At the check-out page 18, the cardholder optionally provides their card information, address, etc., and selects a check-out or other similar purchase completing option 18a provided on the page 18. Upon completing the transaction, transaction data and/or details 40 are generated or otherwise established, e.g., by the server 12. The transaction data 40 typically includes a plurality of data elements that represent the values for the various transaction details. For example, as illustrated, the transaction data 40 includes the following elements: a transaction reference number or ID 40a, a transaction date and/or time 40b, a transaction amount 40c, a card number 40d, a card expiration date 40e, and an optional authentication result or data value 40f.

Depending on the type of card transaction executed, the authentication result or data value 40f may or may not be produced or otherwise established. For example, the cardholder 30 may opt to use a card otherwise accepted by the merchant 10 and/or website 14, but the card is not part of a payment network having an authentication protocol or initiative supported by the website 14 or merchant 10. For distinction purposes, transactions not having an associated authentication result or value 40f are referred to herein as non-authenticated transactions, while transactions having an associated authentication result or value 40f are referred to as authenticated transactions. Of course, even in an authenticated transaction, the actual result or value 40f may represent a positive authentication (e.g., meaning the cardholder 30 passed the authentication process or otherwise had the proper credentials), a negative authentication (e.g., meaning the cardholder 30 did not provide the proper credentials during the authentication process), or a failed authentication (e.g., meaning authentication was attempted in accordance with the authentication protocol or initiative, but no result was achieved or obtained).

When established, the authentication result or data value 40f is suitably obtained from and/or otherwise corresponds to an authentication message and/or data returned or otherwise transmitted to the server 12 and/or merchant 10 in accordance with an authentication protocol or initiative supported by a payment network to which the card used in the transaction belongs. For example, the authentication result or data value 40f is optionally: (i) what is commonly known as an accountholder authentication value (AAV) or a universal cardholder authentication field (UCAF) value produced in connection with the so called MasterCard® SecureCodeTM initiative supported by the MasterCard® payment network; (ii) what is commonly known as a cardholder authentication verification value (CAW) produced in connection with the so called VbV or 3-D Secure® initiative supported by the Visa® payment network; or, (iii) some other like value representative of a similar authentication determination or result. Optionally, the result or data value 40f is encoded or encrypted.

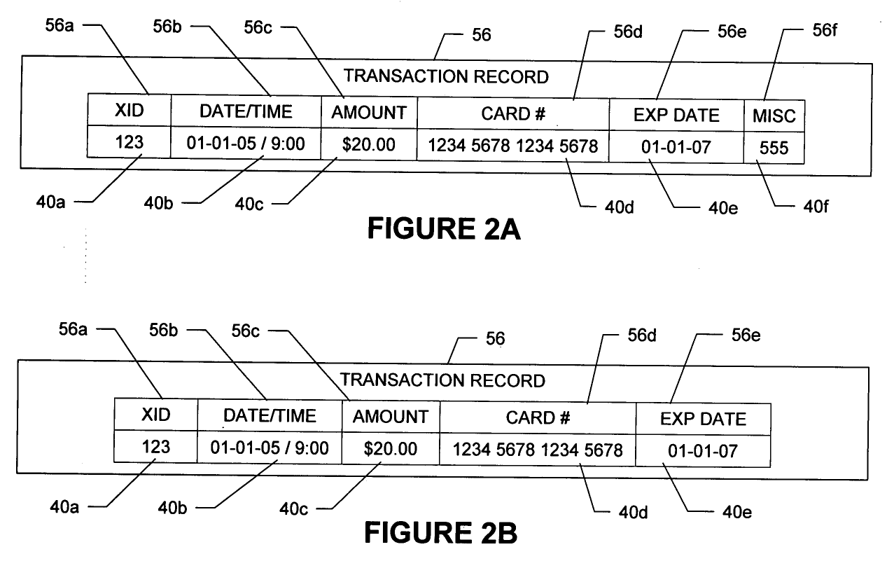

Suitably, the merchant 10 also employs a back-end accounting and/or order management system (OMS) 52, e.g., supported and/or running on a separate server 50 or other like computer. The OMS 52 is suitably implemented via any appropriate accounting or order management platform. Commercially available options include Mail Order Manager® provided by Dydacomp, Everest® provided by iCode, Inc., etc. In the usual manner, the OMS 52 suitably includes and/or employs a transaction database (DB) 54 in which transaction records 56 are maintained (see also FIGS. 2A and 2B). As shown in FIGS. 2A and 2B, each data record 56 includes a plurality of fields, including for example, a transaction reference number or ID field 56a, a transaction date and/or time field 56b, a transaction amount field 56c, a card number field 56d, and a card expiration date field 56e. Optionally, as shown in FIG. 2A, the OMS 52 and/or DB 54 are provisioned with and/or otherwise equipped to support a transaction record 56 with an additional or extra miscellaneous field 56f.

Suitably, the transaction details 40 established by the server 12 for each transaction are transferred to or otherwise obtained by the OMS 52. When the OMS 52 receives transaction data or details 40 for a particular transaction from the server 12, they are mapped to the corresponding fields (as shown) in a transaction record 56 produced or created for that transaction in the DB 54. As previously indicated, non-authenticated transactions have no authentication data present. Accordingly, if the record 56 employed by the OMS 52 is structured as shown in FIG. 2A, then the miscellaneous field 56f is simply left blank, otherwise if it is structured as shown in FIG. 2B, then there is suitably a one-to-one mapping of the data elements 40a through 40e into the fields 56a through 56e as illustrated. Alternately, if the authentication data 40f is present for the transaction and the record 56 employed by the OMS 52 is structured as shown in FIG. 2A, then the authentication data is mapped to the miscellaneous field 56f, otherwise if it is structured as shown in FIG. 2B, then the data elements 40a through 40e are mapped into the fields 56a through 56e as illustrated, and the authentication data 40f is dropped, not sent to, not recorded or otherwise disregarded by the OMS 52.

Optionally, for non-authenticated transactions, the OMS 52 passes or otherwise delivers the transaction records 56 and/or the transaction details 40 contained therein to an acquirer 60 for payment processing. These records 56 may be passed to the acquirer periodically or at other intervals as desired, and they may be passed singularly or in batches. In the usual manner, the acquirer 60 (e.g., a merchant bank, a payment gateway, or the like) then presents or submits the transactions for payment over an appropriate payment network 62 to an issuer 64 (e.g., the bank or other like entity that issued the card used in the transaction). Suitably, the OMS server 50 and the acquirer 60 are both operatively connected to the Internet 20. Accordingly, the transaction records 56 and/or the data 46 contained therein for non-authenticated transactions is optionally transmitted from the server 50 to the acquirer 60 over the Internet 20.

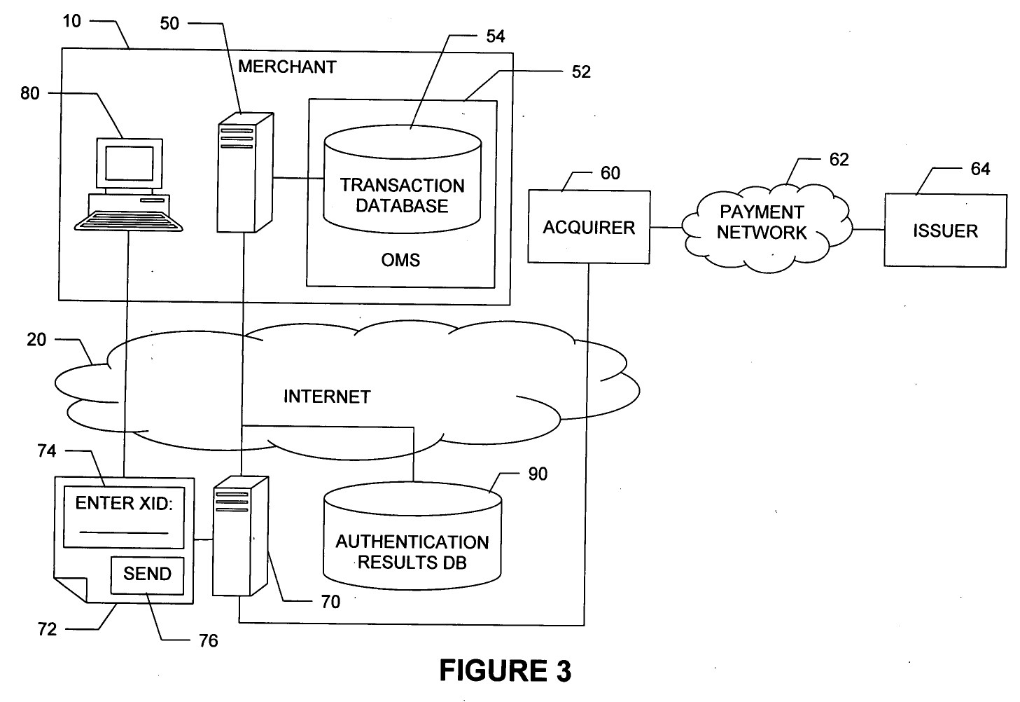

With reference to FIG. 3, the merchant 10 suitably employs an authentication bridge, optionally operated by a third party, to pass authenticated transactions to the acquirer 60. As shown, the authentication bridge is software or a set of instructions implemented via a server 70 or other like computer operatively connected to the Internet 20. Suitably, the merchant 10 selectively accesses the authentication bridge with a web terminal 80 (e.g., implemented as a web or Internet browser running on a computer or other like Internet access device) by connecting to the bridge server 70 over the Internet 20. Alternately, the authentication bridge and/or web terminal 80 are provisioned to automatically process all or some sub-set of the merchant's transactions, and if no relevant authentication data is found or present for a particular transaction, then the authentication bridge simply passes that transaction to the acquirer 60 in the usual manner, e.g., as the merchant 10 would otherwise normally provide it.

As shown, when the authentication bridge is accessed, the bridge server 70 supplies the web terminal 80 with an authentication bridge web page 72 or the like, including an area or field 74 for entering a transaction ID (XID) and a submit or send option 76. Accordingly, the merchant 10, via the web terminal 80, manually or otherwise enters a transaction reference number (i.e., the XID value 40a for an authenticated transaction previously completed) in the entry field 74 and selects the send option 76 to post the page 72 back to the bridge server 70 or otherwise deliver the XID value 40a entered in the field 74 to the authentication bridge. While described with reference to a single authenticated transaction, optionally, a batch or plurality of authenticated transactions are processed together in similar fashion by entering a plurality or range of XID values 40a in the field 74 and then selecting the send option 76.

In a suitable embodiment where the OMS 52 and/or DB 54 support a record structure as shown in FIG. 2A, the authentication bridge responds to receipt of the XID value 40a by retrieving, obtaining or otherwise accessing the corresponding transaction record 56 (i.e., the record 56 with a matching XID value 40a in its XID field 56a) maintained in the transaction record DB 54, for example, by connecting to the OMS server 50 with the bridge server 70 over the Internet 20. Optionally, the authentication bridge is provisioned to recognize or know that the data in the miscellaneous field 56f corresponds to the authentication data 40f. Alternately, when the record 56 is obtained, the authentication bridge parses or otherwise scans the data values 40 to determine which one corresponds to the authentication data 40f, for example, by examining the format, structure and/or values of the individual data elements to find the one that is compatible with or matches an accepted or prescribed format, structure and/or value for authentication data. Having identified the authentication data 40f, the authentication bridge formats and/or orders the data 40 obtained from the retrieved record 56 (including the authentication data 40f) to comply with the data format and/or sequence prescribed or otherwise expected by the acquirer 60. The formatted and/or ordered data 40 is then passed or otherwise delivered to the acquirer 60, e.g., by the bridge server 70 which connects to the acquirer 60 over the Internet 20 or alternately some form of dedicated connectivity. As before, the acquirer 60 then presents or submits the transactions for payment over the appropriate payment network 62 to the issuer 64, this time with the authentication data 40f. Accordingly, the merchant 10 enjoys the full benefit of participation in and/or compliance with the applicable authentication protocol or initiative. Optionally, the acquirer 60 returns a response from the payment processing to the authentication bridge and/or server 70, which in turn optionally formats and forwards the same on to the merchant 10, e.g., over the Internet 20 to the server 50, so that the OMS 52 and/or DB 54 may be properly updated with the status of the transaction (e.g., indicating that payment processing for the transaction is complete and/or indicating a payment status, i.e., paid, denied, etc.).

In an alternate embodiment where the OMS 52 and/or DB 54 support a record structure as shown in FIG. 2B, the authentication bridge cannot obtain the authentication data 40f from the DB 54. However, at times in the authentication process itself, the authentication data 40f is optionally maintained by other parties involved in or facilitating the authentication process, e.g., in an authentication results database 90. Suitably, the authentication results or data 40f maintained in the DB 90 are also identified by their associated XID values 40a. Accordingly, the authentication bridge responds to receipt of the XID value 40a by retrieving, obtaining or otherwise accessing the corresponding authentication data 40fmaintained in the authentication DB 90, for example, by connecting thereto with the server 70 over the Internet 20. The other transaction details or data 40 are obtained from the DB 54 as before, or alternately, if available, from the DB 90. In either case, now having a complete set of transaction details 40 (including the authentication data 40f, the authentication bridge formats and/or orders the data 40 to comply with the data format and/or sequence prescribed or otherwise expected by the acquirer 60, and the formatted and/or ordered data 40 is then passed or otherwise delivered to the acquirer 60, e.g., by the bridge server 70 which connects to the acquirer 60 over the Internet 20. As before, the acquirer 60 then presents or submits the transactions for payment over the appropriate payment network 62 to the issuer 64, this time with the authentication data 40f. Accordingly, the merchant 10 again enjoys the full benefit of participation in and/or compliance with the applicable authentication protocol or initiative. Optionally, the acquirer 60 returns a response from the payment processing to the authentication bridge and/or server 70, which in turn optionally formats and forwards the same on to the merchant 10, e.g., over the Internet 20 to the server 50, so that the OMS 52 and/or DB 54 may be properly updated with the status of the transaction (e.g., indicating that payment processing for the transaction is complete and/or indicating a payment status, i.e., paid, denied, etc.).

In one suitable embodiment where the authentication bridge is not aware of the record structure employed by the OMS 52 and/or DB 54, the authentication bridge is provisioned to check the DB 54 for the authentication data 40f, and if it cannot be found there alternately check the DB 90.

While described herein with reference to an on-line or Internet merchant such as the merchant 10, alternately, other types of merchants (e.g., a mobile merchant (e.g., selling goods and/or service over a wireless telecommunications network), a traditional brick and mortal merchant, etc.) can also beneficially implement and/or utilize a back-end transaction processing system similar to the one described herein. That is to say, suitably, any of a variety of front-end platforms or approaches may be optionally used to generate the transactions (i.e., in person transactions, e-commerce transactions, mobile transactions, etc.), while a similar back-end processing as described herein is still used or otherwise implemented in the manner described.

Additionally, it is to be appreciated that the web terminal and/or bridge may be employed to enable the merchant to accept alternate payment methods (e.g., PayPal®, Bill Me Later®, Secure eBill, Google Checkout, NACHA, etc.) and submit the transaction details to the appropriate payment processing network or entity. That is to say, in some instances the merchant's OMS or other back-end processing may not be equipped or otherwise setup to handle the transaction details associated with one or more alternate payment methods. For example, fields may not be designated or available for the various different types of data elements associated with a transaction conducted using the alternate payment method. Accordingly, the web terminal is used to submit a transaction to the bridge which collects the transaction details, identifies the various data elements and forwards the transaction for processing to the appropriate entity or payment network.

In connection with the particular exemplary embodiments presented herein, certain structural and/or function features and/or elements are described as being incorporated in particular embodiments. These features and/or elements may be selectively implemented via suitable software, hardware, firmware or any combination thereof. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to exemplary embodiments. Obviously, modifications and alterations will occur to others upon reading and understanding the present specification. It is intended that the inventive subject matter be construed as including all such modifications and alterations insofar as they come within the scope of the appended claims or the equivalents thereof.

1. In connection with a transaction conducted between a first party and a second party, wherein a plurality of transaction details related to the transaction are generated, including a transaction ID which identifies the transaction and authentication data which reflects a result of an attempt to authenticate the first party, a method of passing the authentication data to a third party which processes the transaction comprises:
a) providing the second party a document over a communications network, said document requesting a transaction ID;
b) receiving the transaction ID over the communications network from the second party;
c) collecting the transaction details corresponding to the received transaction ID;
d) identifying the authentication data within the collected transaction details;
e) formatting the transaction details according to a prescribed format; and,
f) forwarding the formatted transaction details to the third party.

2. The method of claim 1, wherein the transaction details are collected in step c) from a database maintained in connection with an order management system, said transaction details being stored in a transaction record corresponding to the transaction to which the transaction details relate.

3. The method of claim 2, wherein the transaction record includes a plurality of fields, each field including a name identifying a type of the field and a value representing an element of the transaction details.

4. The method of claim 3, wherein the transaction record includes a first field having a first name and containing a first value, in which the first value represents the authentication data but the corresponding first name identifies the type of the field as otherwise.

5. The method of claim 4, wherein step d) comprises identifying the authentication data as the value contained in the field having the first name.

6. The method of claim 4, wherein step d) comprises parsing the transaction details to locate a value that has an appearance consistent with authentication data.

7. The method of claim 2, wherein the transaction details contained in the transaction record do not include the authentication data, and step c) comprises collecting the authentication data from a location different than the transaction record.

8. The method of claim 1, wherein the communications network is the Internet and the document is a web page.

9. In connection with a transaction conducted between a first party and a second party, wherein a plurality of transaction details related to the transaction are generated, including a transaction ID which identifies the transaction and authentication data which reflects a result of an attempt to authenticate the first party, a system for passing the authentication data to a third party which processes the transaction comprises:
means for providing the second party a document over a communications network, said document requesting a transaction ID;
means for receiving the transaction ID over the communications network from the second party;
means for collecting the transaction details corresponding to the received transaction ID;
means for identifying the authentication data within the collected transaction details;
means for formatting the transaction details according to a prescribed format; and,
means for forwarding the formatted transaction details to the third party.

10. The system of claim 9, wherein the transaction details are collected in from a database maintained in connection with an order management system, said transaction details being stored in a transaction record corresponding to the transaction to which the transaction details relate.

11. The system of claim 10, wherein the transaction record includes a plurality of fields, each field including a name identifying a type of the field and a value representing an element of the transaction details.

12. The system of claim 11, wherein the transaction record includes a first field having a first name and containing a first value, in which the first value represents the authentication data but the corresponding first name identifies the type of the field as otherwise.

13. The system of claim 12, wherein the means for identifying identifies the authentication data as the value contained in the field having the first name.

14. The system of claim 12, wherein the means for identifying parses the transaction details to locate a value that has an appearance consistent with authentication data.

15. The system of claim 10, wherein the transaction details contained in the transaction record do not include the authentication data, and the means for collecting collects the authentication data from a location different than the transaction record.

16. The system of claim 9, wherein the communications network is the Internet and the document is a web page.

17. In connection with a transaction conducted between a first party and a second party, wherein a plurality of transaction details related to the transaction are generated, including a transaction ID which identifies the transaction, a method of passing the transaction details to a third party which processes the transaction comprises:
a) providing the second party a document over a communications network, said document requesting a transaction ID;
b) receiving the transaction ID over the communications network from the second party;
c) collecting the transaction details corresponding to the received transaction ID;
d) identifying the collected transaction details;
e) formatting the transaction details according to a prescribed format; and,
f) forwarding the formatted transaction details to the third party.
